(19) United States
(12) Patent Application Publication
(10) Pub. No.: US 2009/0071543 A1
(43) Pub. Date: Mar. 19, 2009

(54) Fuel Vent Valve And Improvement Thereof

(75) Inventors: Omer Vulkan, D N. Halutza (IL); Moshe Ehrman, D.N. Halutza (IL); Avigail Bar-Lev, Beer Sheva (IL)

Correspondence Address: THE NATH LAW GROUP, 112 South West Street, Alexandria, VA, 22314, US

(73) Assignee: RAVA; A.C.S. LTD., D.n. Halutza (IL)

(21) Appl. No.: 12/224,980

(22) PCT Filed: Feb. 4, 2007
(86) PCT No.: PCT/IL2007/000143

§ 371 Date: Oct. 31, 2008

(30) Foreign Application Priority Data
May 11, 2006 (IL) 175557

(51) Int. Cl. F16K 31/22

(52) U.S. Cl. 137/15.26

(57) ABSTRACT

A fuel valve comprising a primary valve and a pressure responsive auxiliary valve, both being axially accommodated and displaceable within a common housing formed with a fluid inlet and a fluid outlet port, and a partition extending between the primary valve and the auxiliary valve. The partition comprising a flow passage extending between a primary port at a bottom face of the partition and an auxiliary port at a top face of the partition. The primary port is sealable by a sealing member of the primary valve and the auxiliary port sealable by a sealing member of the auxiliary valve.

### FIELD OF THE INVENTION

The present invention generally relates to improvements in rollover vent valves and more particularly the invention is concerned with a rollover vent valve with a two way valve serving as a pressure/under pressure relief valve and as a check valve.

### BACKGROUND OF THE INVENTION

In a fuel system of vehicle there is typically provided a fuel tank associated with a fuel pump module connected by a fuel delivery line to the fuel rail and injectors of the engine, with a plurality of valve means provided to regulate fuel and vapor flow.

One of such valves is the rollover vent valve is designed to allow, on the one hand, for the venting of fuel vapor from a vehicle fuel tank to the atmosphere or to a vapor recovery system such as a carbon canister, and, on the other hand, to ensure the closure of the valve under certain conditions. These conditions can arise either when, as a result of excessive filling of the tank fuel, passes into the valve or, and most significantly, when as a result of a sudden change of position of the tank, such as, for example, when the vehicle and the tank rollover, fuel could escape from the tank through the otherwise opened valve.

It is important to ensure positive opening of the valve, either when the fuel level drops or when the vehicle and its fuel tank return to their normal position. Thus, the larger the vent outlet the greater the differential pressure acting on the valve and, in consequence, the greater the closing force effective on the valve.

Such a rollover vent valves are generally well known, examples thereof being described, inter alia, in U.S. Pat. No. 5,738,132 discloses a rollover vent valve comprising a housing having a fluid inlet and a fluid outlet, the latter comprising a substantially elongated slit-like outlet aperture of the housing bounded by a valve seating. There is furthermore provided a float member located in the housing and axially displaceable within the housing between the inlet and the outlet; an elongated flexible closure membrane strip anchored at one end thereof to an end of the float member adjacent the outlet and at a portion thereof offset with respect to the outlet; spring biasing means located within the housing and bearing on the float member so as to spring bias it in the direction of the outlet; whereby the spring biasing together with buoyancy forces acting on the float member tend to press the membrane strip into sealing engagement with the outlet aperture whilst gravity forces acting on the float member tend to displace the float member away from the outlet so as to progressively detach the strip from sealing engagement with the outlet.

Furthermore, at locations with a hot climate, the fuel in the tank system expands when the drive stops after an operating phase. It is problematic when the fuel expands in the feed line that connects the tank with the combustion engine, resulting in pressure increase in fuel feed line, which may result in fuel leakage or in malfunctioning of the engine. On the other hand, at low environment temperatures and under fuel consumption, pressure within the fuel tank decreases, which may result in deformation or cracking of the fuel tank.

Thus it is a requirement that a fuel system be suited for fuel supply at a relative high flow rate in a direction from the fuel tank to the engine whilst allowing for venting the fuel tank to prevent vacuum in the fuel tank.

For that purpose, it has been suggested to install various types of check valves in line between the fuel valves and the fuel treating device (carbon canister) or other components of the fuel system.

It is an object of the present invention to provide an improved rollover vent valve integrating a rollover vent valve with a double check valve, offering advantages of space economy, manufacturing and installation costs and labor, etc.

### SUMMARY OF THE INVENTION

According to the present invention there is provided a fuel valve suited for fitting in a vehicle's fuel system, and being operative in different conditions as will be explained hereinafter. The valve is an integration of a valve and double check valve serving as a pressure holder (‘pressure retention valve’), thus saving space and costs of manufacturing, assembly and installation.

According to the invention there is provided a fuel valve comprising a primary valve and a pressure responsive auxiliary valve, both being axially accommodated and displaceable within a common housing formed with a fluid inlet and a fluid outlet port, and a partition extending between said primary valve and said auxiliary valve; said partition comprising a flow passage extending between a primary port at a bottom face of the partition and an auxiliary port at a top face of the partition; said primary port sealable by a sealing member of the primary valve and said auxiliary port sealable by a sealing member of the auxiliary valve.

According to a particular design of the invention the primary valve is a rollover valve and where the primary port is a substantially elongated slit-like aperture bounded by a primary valve seating; a float member is axially displaceable within the housing between the fluid inlet and the primary port; where the sealing member of the primary valve is in the form of an elongated flexible closure membrane strip anchored at one end thereof to an end of the float member adjacent primary port and at a portion thereof offset with respect to the primary port; and further there is provided a spring biasing member located within the housing and bearing on the float member so as to spring bias it in the direction of the primary port.

The auxiliary valve comprises a piston member axially displaceable within the housing and comprising a bleeding valve being a check valve facilitating fluid flow only in direction from the fluid outlet port towards the auxiliary port and sealable by the sealing member of the auxiliary valve; and wherein the piston is normally biased into sealing engagement of the auxiliary port and is displaceable to facilitate fluid flow in direction from the auxiliary port towards the fluid outlet port.

The valve according to the present invention functions in accordance with the level of fuel within the fuel tank and further responsive to varying pressure conditions residing within the fuel tank. At the event of rollover of the vehicle, or at steep inclinations, or upon fuel entering the valve housing (e.g. as a result of sudden acceleration/deceleration or high fuel level)—the float member of the primary valve displaces into sealing engagement of the primary port.

Other functional states of the valve are responsive to pressure differences, as follows:
When Pₜₐₙₖ<Pₐₜₘ then the auxiliary port and the primary port open to air the fuel tank namely allow fluid flow from the valve's fluid outlet port towards the valve's fluid inlet;
When Pₐₜₘ<Pₜₐₙₖ<(Pₐₜₘ+P_{spring}) then the auxiliary port and the bleeding valve remain sealed, thus retaining a predetermined pressure within the fuel tank (pressure holding position); and
When Pₜₐₙₖ>(Pₐₜₘ+P_{spring}) then the primary port and the auxiliary port open so as to discharge fuel vapor pressure from the fuel tank, namely allow fluid flow from the fuel tank towards the valve's fluid outlet port.

Wherein:
Pₜₐₙₖ denotes the fuel vapor pressure within the fuel tank;
Pₐₜₘ denotes the atmospheric pressure; and
P_{spring} denotes the effective pressure applied by the biasing effect applied on the piston into sealing engagement of the auxiliary port.

A typical pressure rate at the so called pressure holding position, would be for example in the range of about 3 Kpa<Pₜₐₙₖ<4 Kpa.

The bleeding valve comprises one or more apertures formed in the piston member with a deformable sealing member fitted for sealing engagement of said one or more apertures at the event of flow in direction from the auxiliary port towards the outlet port; and wherein said deformable sealing member deforms to open said one or more apertures so as to facilitate fluid flow in a reverse direction.

By a further specific design, the deformable sealing member is articulated to a bottom face of the piston member and serves also for sealing engagement of the auxiliary port.

The piston member comprises a stud projecting from a bottom wall thereof and fitted for retention of the deformable sealing member; said stud projecting into the auxiliary port whenever the piston member is at its normally biased position, sealingly engaging the auxiliary port.

And by still a particular design a peripheral portion of the deformable sealing member is clamped between a peripheral seal seat of the auxiliary port and a bottom face of the piston member; and wherein a central portion of the deformable sealing member is deformable for sealing/unsealing of the one or more apertures.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIG. 1 is an isometric view of a valve according to the invention;

FIG. 2 is a longitudinal section of a rollover valve according to the present invention, at a so-called open/venting position;

FIG. 3 is an isometric exploded view of the valve of FIG. 1;

FIG. 4 is a longitudinal section of a rollover valve of FIG. 1, in a fully closed position;

FIG. 5 is a longitudinal section of a rollover valve of FIG. 1, with the primary valve open and the auxiliary valve sealed; and

FIG. 6 is a longitudinal section of a rollover valve of FIG. 1, in an exhausting position.

### DETAILED DESCRIPTION OF AN EXEMPLARY EMBODIMENT

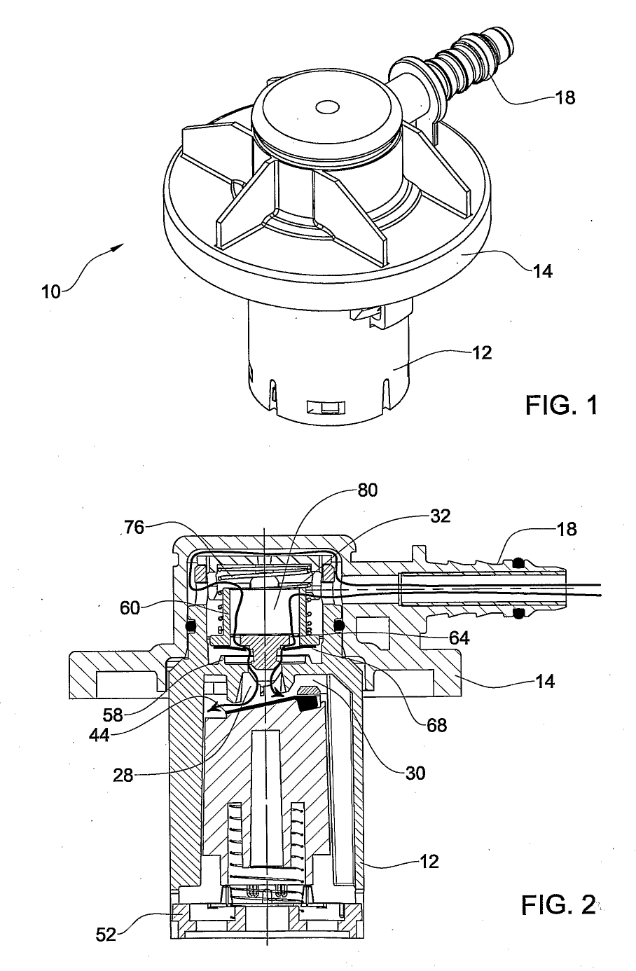

In FIG. 1 there is illustrated a valve in accordance with the present invention generally designated 10 comprising a cylindrical housing 12 depending from a flange 14 fitted for sealing attachments over a top surface of a fuel tank (not shown) such that the housing 12 extends into the space of the fuel tank. Extending from an upper portion of the flange 14 there is a fluid outlet port 18 connectable to a vapor recovery system such as a carbon canister, etc. (not shown).

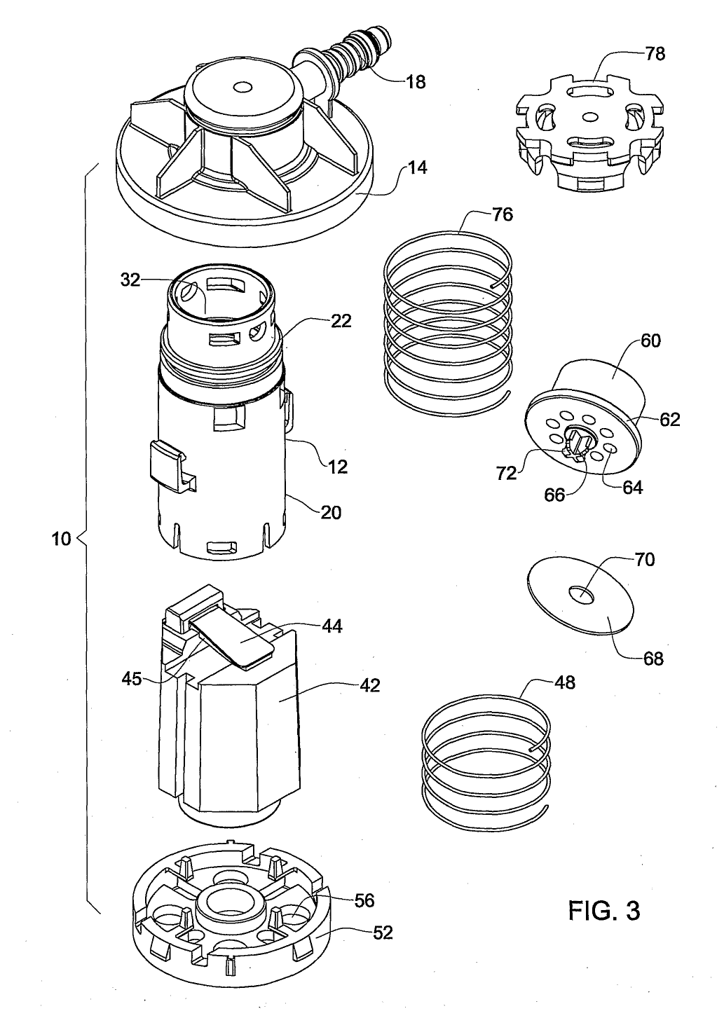

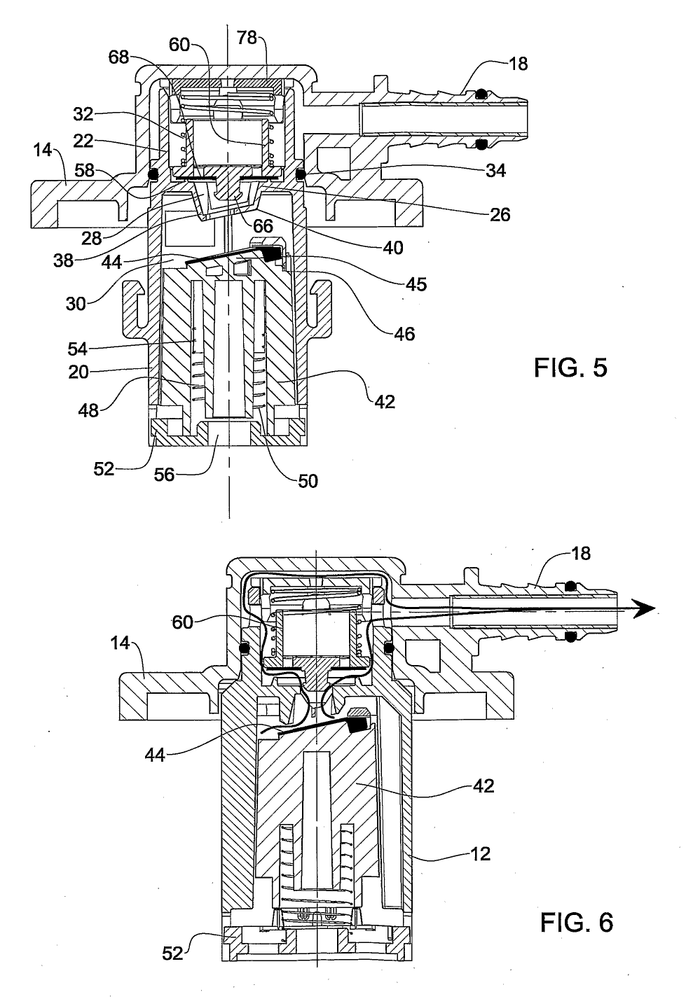

It can further be seen in the section views of FIGS. 2, 4 to 6 and in the exterior view of FIG. 3, the cylindrical housing 12 comprising a bottom portion 20 and an upper portion 22 partitioned from one another by a partition wall 26 (best seen in FIG. 5) formed with a flow path 28 extending between a bottom space 30 and top space 32 as will be discussed hereinafter. The housing 20 is snap fitted into the flange 14 and is sealingly retained by a sealing O-ring 34. The flow path passage 28 is formed at its bottom end, extending within the bottom space 30, a primary port 38 being a substantially elongated slit-like aperture bounded by a primary valve seating 40.

A float member 42 is axially displaceable within the bottom space 38 and is prevented from rotation within the housing owing to axially extending ribs 42 formed in the housing and slidingly received within corresponding recesses formed in the float. An elongated flexible closure membrane strip 44 is anchored at one end thereof 46 to an upper end of the float member 42, offset with respect to a longitudinal axis thereof.

The float member 42 is spring biased in an upward direction by means of a coiled spring 48 bearing at a bottom end thereof 50 against a base 52 of the housing, and at an upper end thereof 54, against a wall portion of the float member. The base member 52 is formed with several apertures 56 constituting a fluid inlet of the valve 10.

It is noted that the elongated flexible closure membrane strip 44 bears on a support surface 45 which inclines and with respect to a longitudinal axis of the valve corresponding with an inclination of the elongated slit-like aperture of the primary valve seating 40.

A top end of the flow passage 28 extends into the top space 32 defining an auxiliary of an auxiliary valve, said auxiliary port defined by a peripheral projection 58.

The top space 32 accommodates an auxiliary valve comprising a piston member 60 axially displaceable within the top space 32 and comprising an annular shoulder 62 at a lower portion thereof formed with a plurality of apertures 64 and a stud 66 fitted for retention of a deformable sealing member 68 formed with a coaxial aperture 70 sized for mounting over said stud 66 such that the deformable sealing member 68 is slidingly displaceable about the stud 66 though presenting from disengagement thereof, owing to lateral projections 72 formed on the stud 66.

The piston member 60 is normally biased in a downward direction by means of a coiled spring 76 bearing at one end against the annular shoulders 62 and at another end against a top base 78 packing together the auxiliary valve components within the top space 32 of the housing.

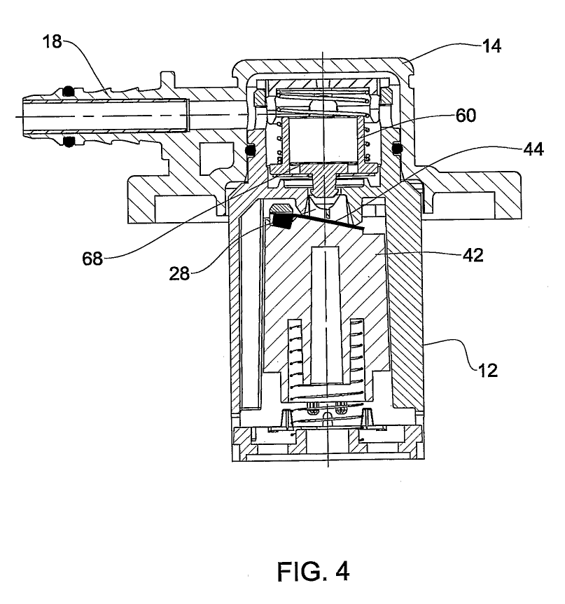

The bottom float member 42 is displaceable between an open position (FIG. 5) where the primary port 38 is entirely open, and a completely closed position (FIG. 4) where the primary port 38 is sealed owing to the elongated flexible closure 44 sealingly bearing against the elongated slit-like aperture 40. It is appreciated that unsealing of the primary port 38 follows the so-called peeling effect as known for example from U.S. Pat. No. 5,738,132 incorporated herein by reference. The primary valve will displace into its sealed position (FIG. 4) e.g. at the event of roll-over of the vehicle or upon significant acceleration or deceleration of the vehicle or upon fuel level raise for the fuel tank.

The auxiliary valve is a two stage check valve formed with a bleeding valve in the form of apertures 64, where the check valve facilitates fluids flow only in direction from the fluid outlet port 18 towards the auxiliary port namely, allowing ingress into the fuel tank (FIG. 2) though preventing fluids flow in an opposite direction.

The arrangement is such that peripheral portions of the deformable sealing member 68 are adapted for sealing engagement over the annular projection 58 constituting the sealing seat of the auxiliary port. The piston member 60 is normally biased into its downward sealing position (FIGS. 2, 4 and 5) by means of the coiled spring 76 which together with the atmospheric pressure tend to displace the piston 60 in the downward direction so as to clamp the peripheral portion of the deformable sealing member 68 into sealing engagement of the auxiliary port.

It is noticed that the piston 60 is in the form of a hollow body with a space 80 communicating between the apertures 64 of the bleeding valve and the top space of the housing.

In the position of FIG. 2, the auxiliary valve is considered to be closed in as far as the piston 60 is downwardly displaced so as to seal the auxiliary port 58. However, in the position of FIG. 2 the bleeding valve is open owing to the formation of the deformable sealing member 68, giving rise to an open fluid flow through the apertures 64, facilitating fluid flow in direction from the outlet port 18, through the top space 32 of the housing, into the space 80 of piston 60 and out through apertures 64, into the flow passage 28 down to the bottom space 30 of the housing and into the fuel tank (not shown).

However, in the position of FIG. 5, the auxiliary port is sealed and similarly, the bleeding valve is sealed in a so-called pressure holding position, wherein the pressure within the fuel tank does not exceed the atmospheric pressure and the biasing effect of the coiled spring 76.

The valve is pressure responsive and operates in three distinct positions as follows, using the following nomenclature:

Pₜₐₙₖ denotes the fuel vapor pressure within the fuel tank;

Pₐₜₘ denotes the atmospheric pressure; and

P_{spring} denotes the effective pressure applied by the biasing effect of the spring member of the auxiliary valve.
When Pₜₐₙₖ<Pₐₜₘ than the auxiliary port and the primary port open to air the fuel tank namely allow fluid flow from the valve's fluid outlet port towards the valve's fluid inlet (FIG. 2);

This position occurs when the pressure within the fuel tank drops below atmospheric pressure and the bleeding valve of the auxiliary valve facilitates air ingress into the fuel tank to thereby prevent generation of under pressure in the fuel tank which may result in damage thereto.
When Pₐₜₘ<Pₜₐₙₖ<(Pₐₜₘ+P_{spring}) then the auxiliary port and the bleeding valve remain sealed, thus retaining a predetermined pressure within the fuel tank (‘pressure holding position’) (FIG. 4);

This position is principally similar to the previous position however with the biasing effect of the coiled spring 76 applying a force so as to insure tight sealing of the auxiliary port.
When Pₜₐₙₖ>(Pₐₜₘ+P_{spring}) than the auxiliary port and the primary port open to air the fuel tank namely allow fluid flow from the valve's fluid inlet port towards the valve's fluid outlet (FIG. 6);

This position occurs with the pressure within the fuel tank exceeds the atmospheric pressure and the force applied by the spring 68, thereby facilitating fluid egress from the fuel tank, however at an accelerated rate.

Whilst an embodiment has been shown and described, it is to be understood that it is not intended thereby to limit the disclosure, but rather it is intended to cover all embodiments, modifications and arrangements falling within the spirit and the scope of the present invention, as defined in the appended claims, mutatis mutandis.

1. A fuel valve comprising a primary valve and a pressure responsive auxiliary valve, both being axially accommodated and displaceable within a common housing formed with a fluid inlet and a fluid outlet port, and a partition extending between said primary valve and said auxiliary valve; said partition comprising a flow passage extending between a primary port at a bottom face of the partition and an auxiliary port at a top face of the partition; said primary port sealable by a sealing member of the primary valve and said auxiliary port sealable by a sealing member of the auxiliary valve.

2. A fuel valve according to claim 1, wherein the primary valve is a rollover valve and where the primary port is a substantially elongated slit-like aperture bounded by a primary valve seating; a float member is axially displaceable within the housing between the fluid inlet and the primary port; where the sealing member of the primary valve is in the form of an elongated flexible closure membrane strip anchored at one end thereof to an end of the float member adjacent primary port and at a portion thereof offset with respect to the primary port; and further there is provided a spring biasing member located within the housing and bearing on the float member so as to spring bias it in the direction of the primary port.

3. A fuel valve according to claim 1, wherein the auxiliary valve comprises a piston member axially displaceable within the housing and comprising a bleeding valve being a check valve facilitating fluid flow only in direction from the fluid outlet port towards the auxiliary port and sealable by the sealing member of the auxiliary valve; and wherein the piston is normally biased into sealing engagement of the auxiliary port and is displaceable to facilitate fluid flow in direction from the auxiliary port towards the fluid outlet port.

4. A fuel valve according to claim 3, wherein the bleeding valve comprises one or more apertures formed in the piston member with a deformable sealing member fitted for sealing engagement of said one or more apertures at the event of flow in direction from the auxiliary port towards the outlet port; and wherein said deformable sealing member deforms to open said one or more apertures so as to facilitate fluid flow in a reverse direction.

5. A fuel valve according to claim 4, wherein the deformable sealing member is articulated to a bottom face of the piston member and serves also for sealing engagement of the auxiliary port.

6. A fuel valve according to claim 4, wherein the piston member comprises a stud projecting from a bottom wall thereof and fitted for retention of the deformable sealing member; said stud projecting into the auxiliary port whenever the piston member is at its normally biased position, sealingly engaging the auxiliary port.

7. A fuel valve according to claim 6, wherein a peripheral portion of the deformable sealing member is clamped between a peripheral seal seat of the auxiliary port and a bottom face of the piston member; and wherein a central portion of the deformable sealing member is deformable for sealing/unsealing of the one or more apertures.

8. A fuel tank fitted with a fuel valve according to claim 1.
